(19) United States
(12) Patent Application Publication
(10) Pub. No.: US 2006/0191509 A1
(43) Pub. Date: Aug. 31, 2006

(54) Codco low pressure gas driven engine operating system

(76) Inventor: James W. Collins, Placerville, CA (US)

Correspondence Address: JAMES W. COLLINS, 1820 TYRREL LANE, PLACERVILLE, CA, 95667, US

(21) Appl. No.: 11/090,603

(22) Filed: Feb. 28, 2005

(51) Int. Cl. F02B 53/00

(52) U.S. Cl. 123/200

(57) ABSTRACT

Sometime in 1925 when I was thirteen years old, my older brother and I were sitting on the floor of his garage, putting together a motorcycle to become my means of transportation. Suddenly he said, “Jim, figure out a way to make the pistons go around in a circle.”I would have forgotten all about this, had I not known that he had reworked the single cylinder engine of an Indian Junior Scout motorcycle for his ninety pound step-daughter to ride in the races, in the desert above the City of San Bernardino Calif. She was continually beating the Harley-Davidson motorcycles. The pistons in “The Codco engine” of, “The Codco low pressure gas driven engine operating system,” go around in a circle.

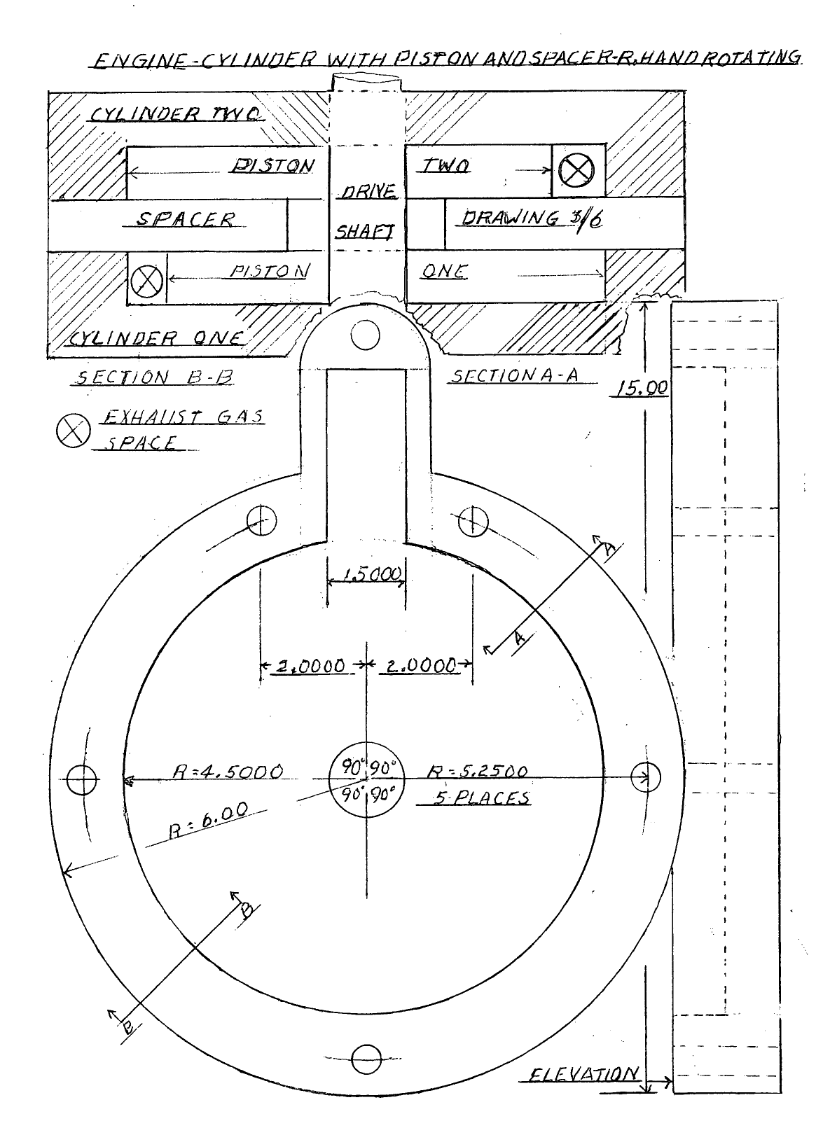

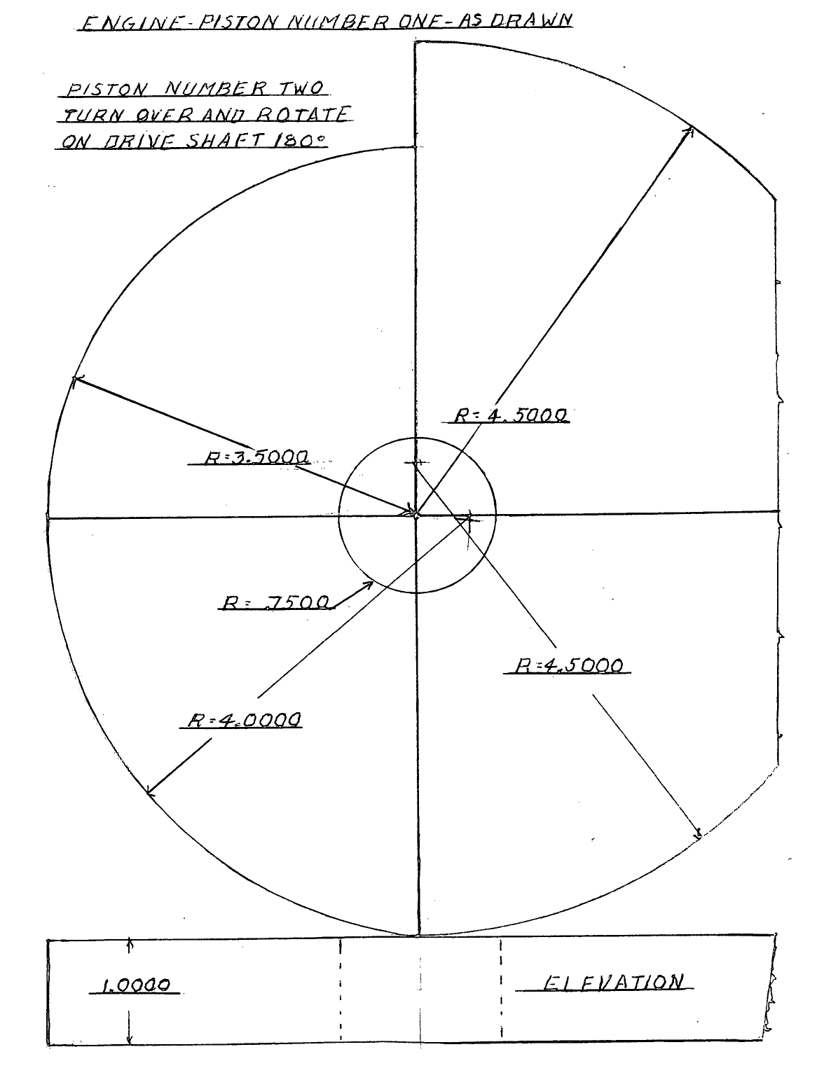

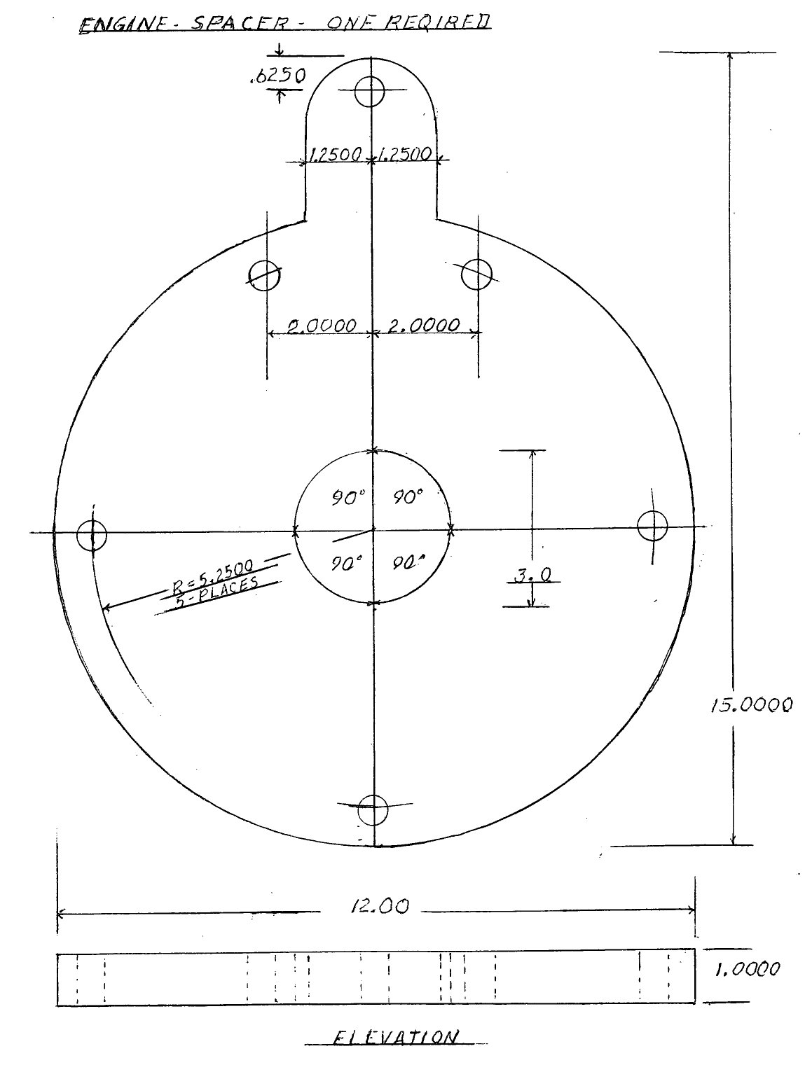

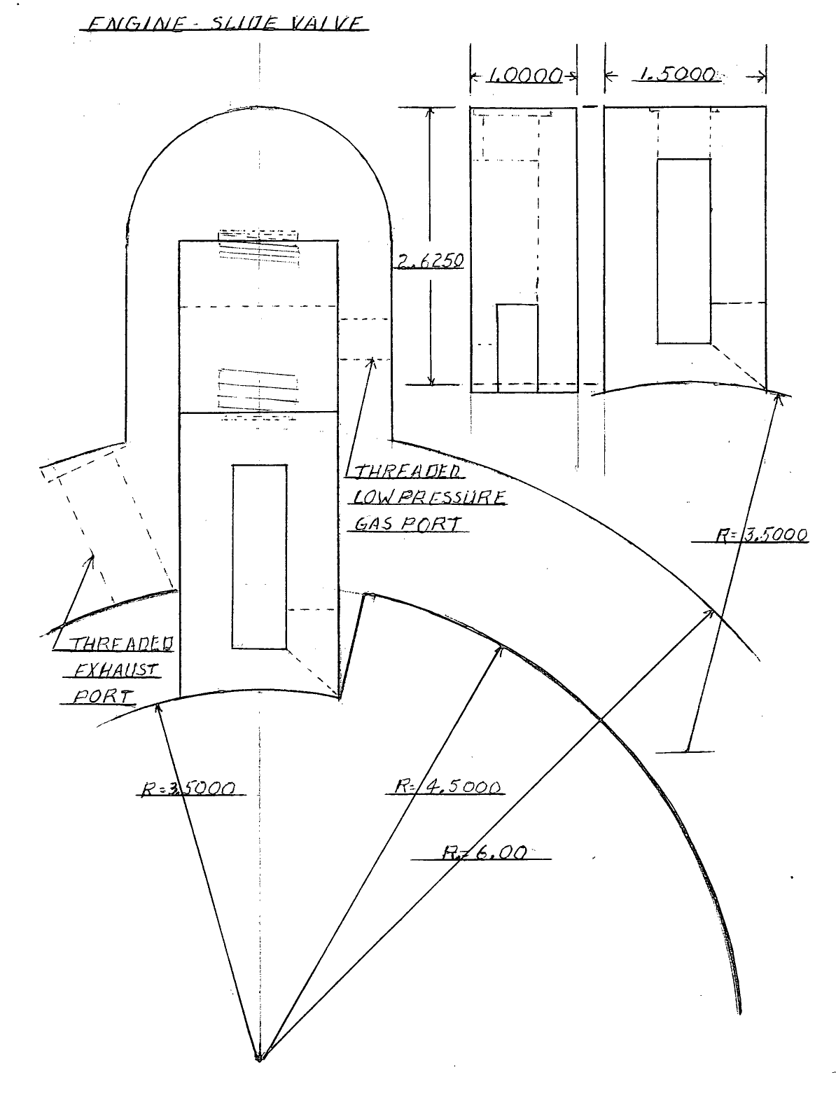

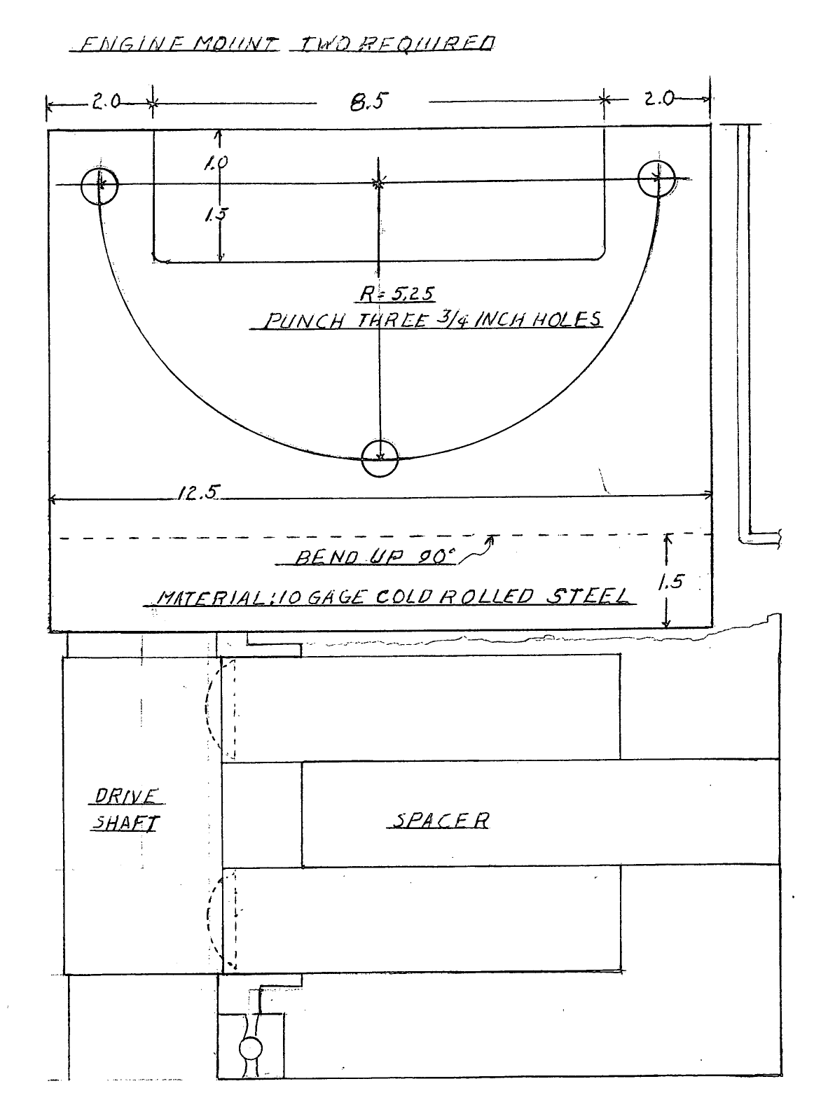

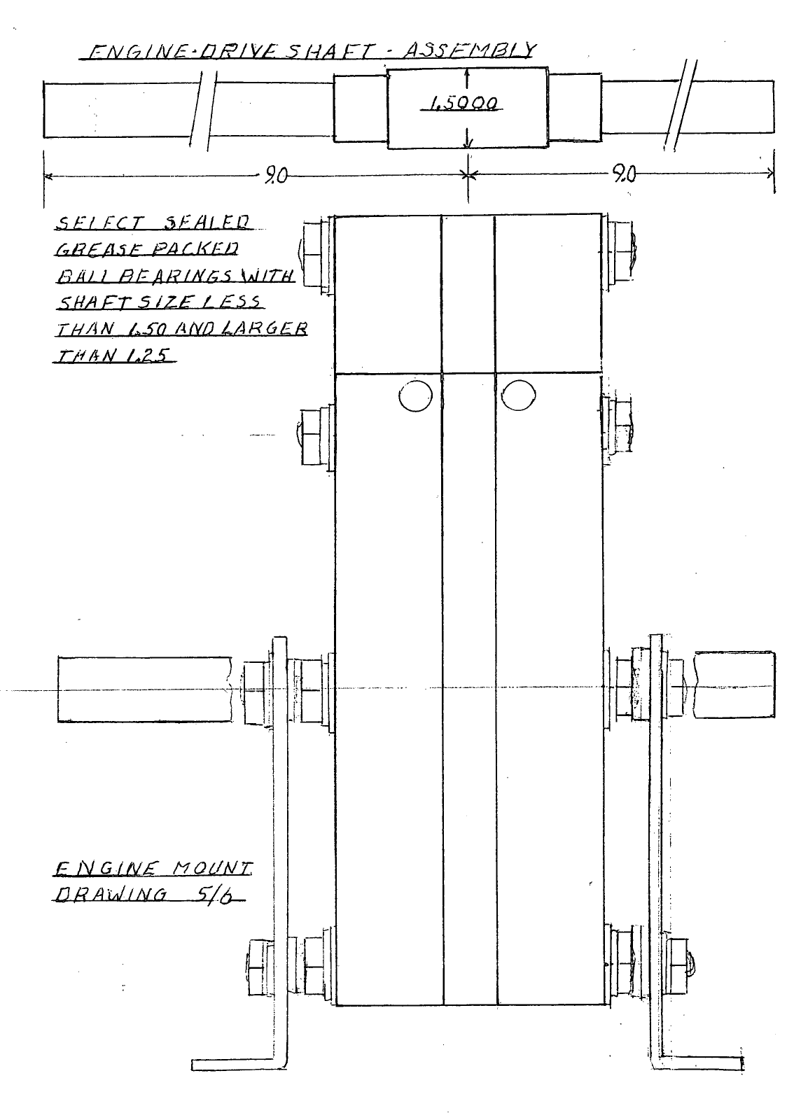

### CROSS-REFERENCE TO RELATED APPLICATIONS

“Not Applicable”

### STATEMENT REGARDING FEDERALLY SPONSORED RESEARCH OR DEVELOPMENT

“Not Applicable”

### REFERENCE TO A MICROFICHE APPENDIX

“Not Applicable”

### BACKGROUND OF THE INVENTION

The modern automobile's four stroke, internal combustion engine is a beautiful example of modern machining practices. Tolerances are so exact that the breaking-in period is nonexistent. With fuel injection and electronic ignition, it starts as well on Christmas day as on the Fourth of July.

Nevertheless, it has drawbacks. It will not run without a flywheel, it weighs a great deal and it idles at somewhat less than one thousand revolutions per minute. (All of which contributes to the fact that automobiles have a lower miles-per-gallon rating for city driving than for freeway driving.)

The automobile is not very efficient at converting heat and pressure into motive power; it's power stroke occurs in each cylinder, only once every two revolutions.

The explosions that occur in it's cylinder heads produce gasses of tremendous heat and pressure; however, the crank arm, determined by the throw of the crankshaft, used to convert the heat and pressure to mechanical energy varies from zero to less than two inches, then back to zero, during it's less than four inch power stroke and then uses another stroke to exhaust the hot gasses. All of this results in a large amount of heat being released into the atmosphere. (From observation; feeling the heat coming off engines after a trip and before they are shut down.)

Consider the weight of an automobile. The engine, transmission, drive shaft, differential, and fluids must add up to half the weight of the automobile. “The Codco low pressure gas driven engine operating system” will surely offer a savings.

### BRIEF SUMMARY OF THE INVENTION

An old adage states “give me a long enough lever and I can move the world.”. “The Codco engine” of my invention, “The Codco low pressure gas driven engine operating system” has a longer lever. Instead of the varying crank arm of less than two inches, it has a constantly mean crank arm of four inches. And instead of the less than four inch stroke, it has a mean stroke of over twenty five inches.

“The Codco low pressure gas driven engine operating system,” with two one inch square pistons, rotating in a circular, square cylinder, with a mean diameter of eight inches, pushed by low pressure gas under two hundred pounds per square inch pressure, could produce 2×1×200×8/2/12=133 foot pounds of torque standing still.

This feature of residual torque will allow for a ratio of one to one for engine speed to drive wheels.

“The Codco low pressure gas driven engine,” has a very efficient “operating system.”. The driver's foot on the throttle will determine the quantity of low pressure gas being used. “The Codco engine,” does not have to idle at stop signs. It could be in a free wheeling mode at any time.

Sixteenth and seventeenth century scientists, Charles, Boyle, and Gay-Lussac and modern experiments, have proven that the kinetic energy of a gas under high heat and pressure does not change when transferred to a larger vessel at a lower heat and pressure. (THE GASEOUS STATE, COLLEGE CHEMISTRY, SECOND EDITION, FREY)

Gasoline being the fuel of choice of most automobile owners we will provide the automobile manufacturers with a method for the production of “low pressure gas.”

A battery driven unit not unlike an air compressor will accept a source of filtered, fuel injected air, compress it, fire it, and expand it into an expansion chamber, using the same engine monitor they are now using to feed the hungry engine they are now building.

We believe there will be a demand for an automobile equipped with “The Codco engine” and a compressed air container for short trips.

Any gas pressure above atmospheric could be considered low pressure. Compressed air, available in most gasoline stations, is a low pressure gas. It is not inconceivable that stations might want to meter it and sell it. Even grocery stores might meter it and sell it.

My invention, “The Codco low pressure gas driven engine operating system,” proposes to introduce an operating system that will be so efficient, it will replace the present day internal combustion automobile engine.

### BRIEF DESCRIPTION OF THE SEVERAL VIEWS OF THE DRAWINGS

Unless indicated otherwise, all parts of “The Codco engine,” are made of alloy steel equal to 4130 with a tensile strength of one hundred fifty thousand pounds per square inch.

Drawing 1/6 Engine-cylinder with piston and spacer, right hand rotating, shows plan and elevation views of one cylinder of a two cylinder engine. It is a twelve inch circular unit, two inches thick with a projection at the top. The nine inch diameter by one inch deep, machined area in the center has a flat bottom that extends into the projection at the top. The two sections, A-A & B-B, show the unusual periphery of the piston and how the spacer makes a fourth side pocket for the piston.

Two of the cylinders are required for the engine assembly. They are symmetrical at this stage; make two cylinders, and hold one for later use.

Drawing 2/6, in full, with a little engineering license, shows plan and elevation views of pistons, whose diameter smoothly increases from three and one half inches to four and one half inches. Note key ways for half moon keys embedded in drive shaft.

The upper left quadrant of the piston has a constant diameter of three and one half inches. In the lower left quadrant, using a four inch radius with a point to point center, the diameter of the piston has increased by one half inch. Moving to the lower right quadrant, using a four and one half inch radius with a point to point center, the diameter is increased to four and one half inches, and matches that of the piston in the top right hand quadrant. As noted on the drawing, key the number one piston to the drive shaft and make another one to be held for the second cylinder.

Drawing 3/6 Engine Spacer, shows the plan and elevation views of a flat unit, which is one inch thick with a three inch diameter hole in the center. It's perimeter and the positioning of the six through holes match those of the engine's cylinders. One unit is required per assembly.

Drawing 4/6, shows in full, the one and one half inch wide by three and one quarter inch long machined area in the projection at the top of the cylinder in drawing 1/6. Two views are also shown of a slide valve to be operated in that area. Note that the piston of number one cylinder has moved to the right enough to allow the spring loaded slide valve to rest on the three and one half inch radius portion of the piston's periphery. One can visualize how low pressure gas entering the port on the right would move through the dotted apertures in the slide valve and behind the piston, moving it in a right hand circular direction.

Piston number two for cylinder number two, is turned over and positioned on the drive shaft, one hundred eighty degrees from piston number one. Since it is being assembled to rotate to the left, the entry port for low pressure gas should be drilled on the left, and the exit for exhaust gas drilled on the right. The exit for low pressure gas from the slide valve will be on the left also. Being rotated one hundred eighty degrees, piston number two, would be positioned close to the median between the lower left and right quadrants, with the slide valve about half closed. When the second cylinder is turned over and placed on top of the Spacer, both entry and exit ports will be on the same side as those of cylinder number one, and piston number two will be turning in the correct circular direction.

It is very important to have the pistons one hundred eighty degrees apart. There will always be a slide valve in position to feed low pressure gas to, at least, one piston no matter the position in which the engine stops. No dead centers.

Drawing 5/6 Engine Mount; two required. Made of the material shown, they will be bolted to either side of “The Codco engine,” using the threaded rods with extended threads.

The cross section, in full, at the bottom of the drawing, may be helpful in showing how the drive shaft, housing, and shaft races of the ball bearings and pistons work together to give “The Codco low pressure gas driven engine operating system,” it's working force.

Drawing 6/6 Engine—Drive Shaft Assembly.

The drive shaft is a very important part of the engine assembly. It will have been machined to receive four half-moon keys, centered one half inch in from each end of the central one and one half inch diameter portion of the drive shaft. The bearing manufacturer's recommended dimension for the inner race of the bearing used, will have been machined in the two places.

The remaining portion at each end will have been machined to the largest diameter possible, after leaving, at least, five one thousands clearance for the inner race of the bearing used with each end of the shaft machined as noted.

Assembly will not be easy; but, with proper tools and benches, there will be no problem.

### DETAILED DESCRIPTION OF THE INVENTION

“The Codco low pressure gas driven engine operating system” needs a supply of low pressure gas to run. My college chemistry book gives a great deal of information about the gaseous state and quotes a general law “The volume of a given mass of gas depends on the temperature and pressure under which it exists.” Without getting into the experiments of sixteenth and seventeenth century scientists, Charles, Boyle and Gay-lussac, we know that a controlled expansion of gasses of high temperatures and pressures developed in the cylinder heads of modern automobile engines, would greatly increase in volume.

Consider a unit similar to an air compressor with zero clearance and two way reed valves driven by an automobile or truck battery. Triggered by a pressure sensor, key or other means, an electronic engine monitor would cause the unit to draw in filtered fuel injected air, explode it, and direct it into the first section of an insulated expansion chamber. At a determined temperature and pressure, the unit would cycle or shut down.

The expansion chamber should be made in two sections, separated by a screen, which would prevent flame from entering the second section, from which low pressure gas would be drawn by “The Codco Engine” of “The Codco low pressure gas driven engine operating system.” All of the safety devices governing pressurized tanks would be utilized. A dump valve, triggered by the automobile's gas bag control, would relieve the pressure in the expansion chamber, in the event of an accident.

There are many gasses, in the liquid state, and/or under high pressures, used by industries, that could, by controlled expansion, become a fuel of low pressure gas. I believe, for safety reasons, that the umbrella of the patent should forbid the use of anything, including compressed air, as a fuel for “The Codco Engine,” of “The Codco low pressure gas driven engine operating system,” without the written direction and consent of the patent owner.

1. What I claim as my invention: “The Codco low pressure gas driven engine operating system,” and any attempt to alter, mimic or infringe on the operating system, as herein after elucidated be done, only with the written consent of the patent owner or his assignees.

2. I claim: the preparation or storage, by whatever means of “low pressure gas,” including air, to be used as a fuel or propellant for “The Codco engine” of “The Codco low pressure gas driven engine operating system,” be limited to the owner of the patent or his assignees.

3. I claim: there are many industrial gasses, including air, under high pressures, that could, by using heat exchangers, pressure reducing devices or any other means, become a low pressure gas and or a fuel or propellant for, “The Codco engine” of “The Codco low pressure gas driven engine operating system.” Such action should take place, only with the written consent of the owner of the patent or his assignees.

4. I claim: the fabrication of an engine with a circular cylinder and with piston or pistons, moving around in a circle, attached to a drive shaft, and propelled by low pressure gas giving the piston a constant crank arm equal to the mean radius of the cylinder and a constant stroke equal to the mean circumference of the cylinder, all of unlimited size and or number, be limited to the owner of the patent or his assignees.

5-20.
